(19) United States
(12) Patent Application Publication
(10) Pub. No.: US 2001/0033038 A1
(43) Pub. Date: Oct. 25, 2001

(54) Method of producing metal/ceramic composite, and method of producing porous ceramic body

(75) Inventors: Shinji Sakaguchi, Nagoya (JP); Shinzo Hayashi, Nagoya (JP); Takayuki Kawae, Nagoya (JP)

Correspondence Address: BURR & BROWN, PO BOX 7068, SYRACUSE, NY, 13261-7068, US

(73) Assignee: NGK Insulators, Ltd.

(21) Appl. No.: 09/810,199

(22) Filed: Mar. 16, 2001

(30) Foreign Application Priority Data
Mar. 27, 2000 (JP) 2000-086,176

(51) Int. Cl. B29C 67/20

(52) U.S. Cl. 264/44; 164/79

(57) ABSTRACT

There is provided a method of producing a metal/ceramic composite, comprising the steps of adding starch to a ceramic slurry; casting the slurry into a water-nonabsorptive mold; heating the slurry to harden it to obtain a hardened body; demolding the hardened body out of the mold; and drying the hardened body to obtain a molded body; and then impregnating pores of the molded body or pores of a porous ceramic body produced by firing the molded body with a metal. The method can produce a metal/ceramic composite having a narrow metal distribution at a low cost, while freely controlling metal content as designed for complex shapes, or products with varying thickness or highly thick products, to say nothing of simple shapes.

### BACKGROUND OF THE INVENTION AND RELATED ART STATEMENT

The present invention relates to a method of producing a metal/ceramic composite, and also to a method of producing a porous ceramic body having communicating pores. The metal/ceramic composite produced by the present invention is highly dense and suitable for tools for various furnaces. The porous ceramic body produced by the present invention is suitable mainly for producing metal/ceramic composites.

A metal/ceramic composite has been generally produced by impregnating a porous ceramic body produced beforehand with a metal. Therefore, quality of the metal/ceramic composite produced by the above procedure greatly depends on the method by which the porous ceramic body is produced.

One of the methods of producing a porous ceramic body comprises adding a pore-forming agent, an organic binder, and the like to stock powder and mixing them; molding an obtained mixture; and firing a dried molded body to obtain a porous ceramic body. In another method, a firing temperature lower than that for producing a dense ceramic is used during the process of producing the dense ceramic body to obtain a porous ceramic body.

Each method involves a molding step, e.g., press molding, injection molding, or casting, of which press molding is not suitable for complex shapes. Casting for complex shapes is not suitable for molding thick-wall products and products with varying thickness. The other problems involved in this method include short serviceability of the mold and necessity for a binder. Injection molding needs a very high facility cost, which is one of the major disadvantages associated therewith.

The method of producing a porous ceramic body comprising the steps of adding a pore-forming agent, an organic binder, and the like to stock powder and mixing them; molding an obtained mixture; and firing a dried molded body to obtain the porous ceramic body has its own disadvantages: e.g., difficulty in debinding because of large quantities of the pore-forming agent and organic binder burned, and the products being fairly easy to crack.

The conventional method of producing a metal/ceramic composite is limited to these method of producing the porous ceramic body, and no method has been established yet for producing a complex shape products, or products with varying thickness or highly thick products having a narrow metal distribution at low cost, while freely controlling metal content.

### SUMMARY OF THE INVENTION

The present invention has been achieved to solve the above problems. It is an object of the present invention to provide a method of producing a metal/ceramic composite having a narrow metal distribution at a low cost, while freely controlling metal content as designed for complex shape products, or products with varying thickness or highly thick products, to say nothing of simple shapes, in production of metal/ceramic composites. It is another object of the present invention to provide a method of producing a porous ceramic body suitable for producing metal/ceramic composites.

According to the present invention, there is provided a method of producing a metal/ceramic composite, comprising the steps of adding starch to a ceramic slurry; casting the slurry into a water-nonabsorptive mold; heating the slurry to harden it to obtain a hardened body; demolding the hardened body out of the mold; drying the hardened body to obtain a molded body; and then impregnating the molded body with a metal in its pores to obtain the metal/ceramic composite.

It is preferable for the above method to use silicon carbide as ceramic and silicon or copper as a metal.

According to the present invention, there is provided a method of producing a metal/ceramic composite, comprising the steps of: adding starch to a ceramic slurry; casting the slurry into a water-nonabsorptive mold; heating the slurry to harden it to obtain a hardened body; demolding the hardened body out of the mold; drying the hardened body to obtain a molded body; firing the molded body to obtain a porous ceramic body; and impregnating the body with a metal in its pores to obtain the metal/ceramic composite.

It is preferable for the above method to use silicon carbide as ceramic and silicon or copper as a metal.

According to the present invention, there is also provided a method of producing a porous ceramic body comprising the steps of adding starch to a ceramic slurry; casting the slurry into a water-nonabsorptive mold; heating the slurry to harden it to obtain a hardened body; demolding the hardened body out of the mold; drying the hardened body to obtain a molded body; and then firing the molded body to obtain the porous ceramic body, wherein the porous ceramic body is obtained by increasing a ceramic particle size so that firing-induced shrinkage of said body hardly occurs.

The method of the present invention can make an open porosity of the porous ceramic body to be 30% or more but 60% or less by changing a starch content of the ceramic slurry.

### BRIEF DESCRIPTION OF THE DRAWINGS

FIG. 1 schematically shows a sintering mechanism involved in the production of the porous ceramic body of the present invention.

FIG. 2 presents a photograph of the microstructure of the Si/SiC composite of the present invention.

FIG. 3 presents a photograph of the microstructure of the SiC cast impregnated with Si, prepared by COMPARATIVE EXAMPLE.

### DETAILED DESCRIPTION OF PREFERRED EMBODIMENTS

The present invention will be described below by the preferred embodiments, which by no means limit the present invention, needless to say.

The method of the present invention for producing a metal/ceramic composite (first method) gives a product having a narrow distribution of density over the entire body, irrespective of thickness or shape of each portion, even when it has a complex shape, and a narrow metal distribution free of bias in the composite impregnated with a metal. It can also easily and freely control a metal content by changing a starch content of a ceramic slurry.

The molded ceramic body can be impregnated with a metal in its pores by, e.g., melting the metal placed on the dried body in an inert gas atmosphere and penetrating it into the pores. The mechanisms by which the molded ceramic keeps its shape while the fused metal is penetrating into the pores are not well understood. It is considered, however, that the ceramic particles are attracted to each other by the van der Waals force to keep the shape of the molded body, which is further promoted by a capillary attraction force, generated by the molten metal, which wets the ceramic particle surfaces well, wetting the body from the portions at which the particles come into contact with each other (such a portion is referred to as a neck).

The molded ceramic body, filled with the molten metal in the gaps between the ceramic particles and spaces surrounded by the particles, turns into the firm metal/ceramic composite, as it is cooled to solidify the metal. The metal is preferably well wettable for the ceramic, and preferably silicon when the ceramic is silicon carbide.

The method of the present invention for producing a metal/ceramic composite (second method) comprises the steps of adding starch to a ceramic slurry; casting the slurry into a water-nonabsorptive mold; heating the slurry to harden it to obtain a hardened body; demolding the hardened body out of the mold; drying the hardened body to obtain a molded body; firing the molded body to obtain a porous ceramic body; and impregnating the body with a metal in its pores to produce the metal/ceramic composite.

The porous ceramic body produced by the present invention has a narrow open porosity distribution over the entire body, because it is produced by firing the dried molded body having a narrow distribution of density over the entire body, irrespective of thickness or body of each portion, even when it has varying thickness, is very thick, or has a complex shape.

The metal/ceramic composite produced by impregnating such a porous ceramic body of narrow open porosity distribution with a metal has also a narrow metal distribution, irrespective of thickness or shape. The fired porous ceramic body can be impregnated with a metal in its pores by various methods, including but not limited to by melting the metal placed on the porous ceramic body in an inert gas atmosphere and penetrating the metal into the pores under normal pressure; by pressing the molten metal into the pores; and by solidifying the metal vapor in the pores. The method of the present invention can produce the metal/ceramic composite with a narrow metal distribution, even when it is impregnated with a metal of low wettability for the ceramic body.

One of the characteristics of the method of the present invention for producing a porous ceramic body (third method) is that the porous ceramic body with communicating pores is produced by increasing a size of ceramic particles so that firing-induced shrinkage hardly occurs.

Another characteristic is that the dried molded body (green compact) is a dried molded body produced by the method comprising steps of adding starch to a ceramic slurry; casting the slurry into a water-nonabsorptive mold; heating the slurry to harden; demolding the hardened body out of the mold; and drying the body.

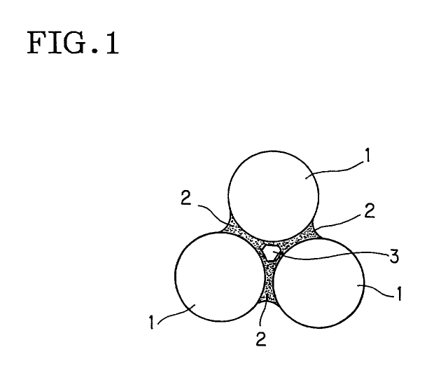

In the present invention, increasing a size of the ceramic particles so that firing-induced shrinkage hardly occurs means that firing is conducted without large shrinkage during the step of firing the coarse ceramic particles that constitute the dried molded body, since evaporation and condensing or diffusion phenomena as illustrated in FIG. 1, causes. The evaporation of ceramic particles 1 from the surface and condensation to the inter-particle contact sections (neck sections) 2, or diffusion into the inter-particle contact sections (neck sections) 2 of atoms in the vicinity of the particle surface, cause to connect the inter-particle contact sections (neck sections) 2 firmly, while keeping a center-to-center distance between the particles 1 essentially intact, and hence to substantially control shrinkage of the body.

During ordinary firing of a ceramic body, the particles are generally sintered through the viscous flow or intra-particle diffusion, which is accompanied by decreased a center-to-center distance between the particles, and reduced gaps between the particles and spaces surrounded by the particles, to close or eventually destroy the pores. The pores formed by burning the starch will remain as the closed pores.

In contrast, the method of the present invention fires the coarse ceramic particles to substantially control shrinkage of the ceramic body, keeping the pore 3 surrounded by the particles 1, which is connected to the pores formed by burning the starch (not shown). As a result, the porous ceramic body as a whole keeps communicating pores even after being fired.

Moreover, the dried molded body has a narrow density distribution over the entire body irrespective of thickness or shape, because it is produced by the method comprising the steps of adding starch to a ceramic slurry; casting the slurry into a water-nonabsorptive mold; heating the slurry to harden; demolding the hardened body out of the mold; and drying the body. The water-absorptive mold, e.g., that of gypsum, generally used for forming body of ceramic slurry can only give a thin-wall product or thick-wall product of uniform thickness. A body with varying thickness has varying density in each section, and a very thick body cannot be produced, when such a mold is used.

The method of the present invention produces a porous body which has a narrow distribution of density over the entire body irrespective of thickness or shape, even when it has varying thickness, is very thick or has a complex shape. Water added to the ceramic slurry totally remains either in the gel with starch or as water present in the gaps between the ceramic particles that constitute the body.

The dried molded body is fired in such a way to control shrinkage, and the resultant porous body secures, in each portion, open pores and open porosity which can be freely and easily controlled at 30 to 40% by changing a starch content. It is also cracked only to a limited extent during the firing step. The porous ceramic body of the present invention thus produced can give the high-quality metal/ceramic composite having a narrow metal distribution, irrespective of shape or thickness.

The above-described porous ceramic body of the present invention, whose particles are increased in size to substantially prevent firing-induced shrinkage, is suitably used for the method of the present invention for producing a metal/ceramic composite (second method). Another type of porous ceramic body used for the method of the present invention is the one produced using a material, such as alumina, which is densified when fired. The dried molded body in this case also has a narrow density distribution over the entire body, irrespective of shape or thickness, because it is produced by the method comprising the steps of adding starch to a ceramic slurry; casting the slurry into a water-nonabsorptive mold; heating the slurry to; demolding the hardened body out of the mold; and drying the body.

The dried molded body thus produced has a narrow distribution of density over the entire body irrespective of thickness or shape, even when it has varying thickness, is very thick or has a complex shape. Water added to the ceramic slurry totally remains either in the gel with starch or as water present in the gaps between the ceramic particles that constitute the body.

The porous ceramic body produced by firing the dried molded body of alumina or the like which is densified when fired, has open pores and open porosity in each portion, where open porosity can be freely and easily controlled at 5 to 60% by changing a starch content. The porous ceramic body preferably has an open porosity of 20 to 60%, more preferably 30 to 60%, in order to give the high-quality metal/ceramic composite having a narrow metal distribution.

The method of the present invention for producing a metal/ceramic composite (second method) is suitable for producing the composite of narrow metal distribution by impregnating the porous ceramic body of narrow open porosity distribution with a metal. Production of the metal/ceramic composite of narrow metal distribution is not the sole area to which this method is applicable. For example, it is also applicable to production of a metal/ceramic composite with the metal concentrated in the surface layer by impregnating, with the metal, the porous ceramic body having an open porosity of 20% or less only in the vicinity of the surface area.

The volumetric proportion of water and starch in the slurry is preferably around 80% or less, although varying depending on type of the ceramic material. At above around 80%, drying the molded body may become difficult, and increased porosity may be no longer expected.

The starch is present preferably at 2 parts by weight or more per 100 parts by weight of the powdered ceramic material. At below 2 parts by weight, the molded body may be excessively soft before drying, and deformed excessively.

Various types of oxide and non-oxide ceramic materials may be useful for the present invention, including alumina, zirconia and silicon carbide. However, the preferable ones are those sintered through the evaporation/condensation mechanisms, e.g., silicon carbide.

Starch simultaneously works as the pore-forming agent and binder, and hence another type of organic binder can be saved, which reduces a material cost and improves workability. A hardened resin can be saved, reducing a quantity of the gases generated by burning during the firing step and demolded out of the body inside, and hence accelerating the firing schedule, improving productivity and reducing cost.

The water-nonabsorptive mold for the present invention may be of a metal, resin or the like, and not limited so long as it is not water-absorptive. However, it is preferably thermoconductive and wear-resistant. Such a mold is free of problems, e.g., clogging, and serviceable for longer periods.

The present invention will be described more concretely by EXAMPLES.

### EXAMPLE 1

A mixture of 60 parts by weight of powdered SiC having an average particle size of around 100 μm, 40 parts by weight of powdered SiC having an average particle size of around 3 μm, 0.15 parts by weight of a dispersant (ammonium polycarboxylate salt) and 22 parts by weight of ion-exchanged water was milled in a pot to prepare an SiC slurry. A given quantity of potato starch was added to the slurry, and the mixture was cast into a water-nonabsorptive mold and heated at 90° C. to form a molded body. It was dried by a hot wind type drier to prepare the dried molded body.

The above dried molded body was debindered in a nitrogen atmosphere and fired at 2300° C. in an argon atmosphere.

Open porosity levels of the porous body samples of fired SiC thus prepared are given in Table 1.

TABLE 1

| | Sample 1 | Sample 2 | Sample 3 |
|---|---|---|---|
| Starch content (parts by weight) | 2.5 | 10 | 20 |
| Starch and water content (vol.%) | 43 | 53 | 61 |
| Open porosity of the fired SiC (%) | 42 | 48 | 51 |

### EXAMPLE 2

The porous body of fired SiC prepared in EXAMPLE 1 was impregnated with molten copper by pressing to prepare the Cu/SiC composite. The volumetric Cu contents of the composite samples are given in Table 2.

TABLE 2

| | Sample 4 | Sample 5 | Sample 6 |
|---|---|---|---|
| Starch content (parts by weight) | 2.5 | 10 | 20 |
| Cu content of the CU/SiC composite | 42 | 48 | 51 |
| (vol. %) | | | |

### EXAMPLE 3

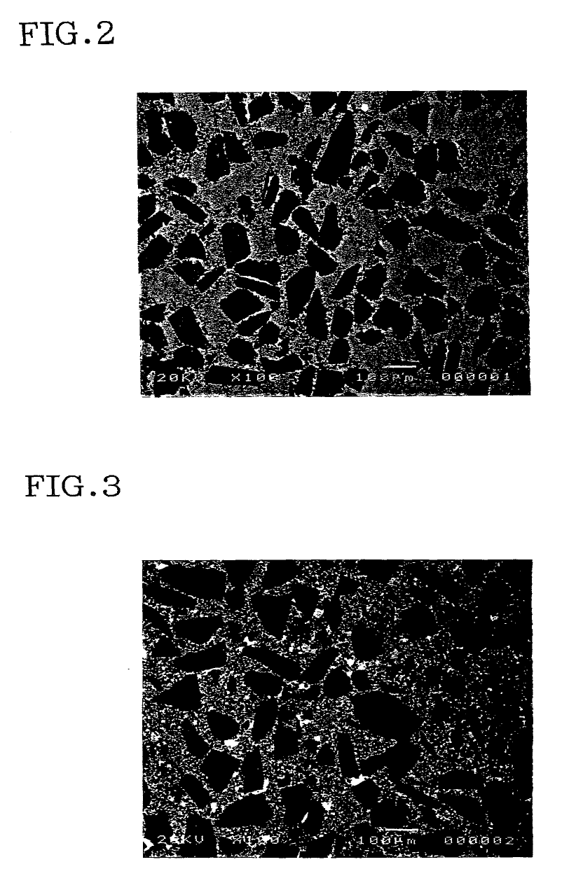

The dried molded body of SiC having the same starch content as in Sample 1 shown in Table 1 was prepared in the same manner as in EXAMPLE 1, and impregnated with Si by placing Si on the SiC dried molded body, heating, and melting to prepare the Si/SiC composite. It had a SiC content of around 34%. FIG. 2 presents the photograph of its microstructure, where SiC and Si are represented by the black and white sections, respectively.

### EXAMPLE 4

A mixture of 100 parts by weight of powdered Al₂O₃ having an average particle size of around 0.5 μm, 0.5 parts by weight of a dispersant (ammonium polycarboxylate salt) and 25 parts by weight of ion-exchanged water was milled in a pot, to prepare the Al₂O₃ slurry. A given quantity of potato starch was added to the slurry, and the mixture was cast into a water-nonabsorptive mold and heated at 85° C. to form the molded body. It was dried to adjust a water content to obtain a dried molded body, debindered in the air, and fired at 1600° C. The porous body thus prepared was then impregnated with molten Al by pressing to prepare the Al/Al₂O₃ composite. Al contents (vol. %) of the Al/Al₂O₃ composite samples (Samples 7 to 11) are given in Table 3.

TABLE 3

| | | Sample | Sample | Sample | Sample |
|---|---|---|---|---|---|
| | Sample 7 | 8 | 9 | 10 | 11 |
| Starch content | 5 | 20 | 40 | 50 | 75 |
| (parts by weight) | | | | | |
| Starch and water | 57 | 63 | 72 | 76 | 81 |
| content (vol.%) | | | | | |
| Open porosity of the | 2 | 30 | 50 | 56 | 47 |
| fired Al₂O_{3 (%)} | | | | | |
| Closed porosity of | 17 | 9 | 3 | 2 | 2 |
| the Al₂O_{3 (%)} | | | | | |
| Al content of the | 2 | 30 | 50 | 56 | 47 |
| Al/AL₂O₃ composites | | | | | |
| (vol.%) | | | | | |

Sample 7 shown in Table 3 contains 5 parts by weight of starch added, and its composite has an Al content of 2 vol. %. The major characteristics of Sample 7 are the composite being impregnated with 2 vol. % of Al only in the vicinity of the surface area, and the porous body having closed pores at the center in the thickness direction. The results for Samples 8 to 10 indicate that the composite is impregnated almost evenly with Al when 20 parts by weight or more of starch is added, and very evenly with Al when 40 to 50 parts by weight of starch is added.

For Sample 11, a total content of starch and water exceeds 80 vol. % in the slurry when starch is added at 75 parts by weight. It has a lower open porosity than Sample 10 with starch added at 50 parts by weight, indicating that it is difficult to have the crack-free fired porous body, when starch is added to 75 parts by weight or more.

### COMPARATIVE EXAMPLE

The molded body of SiC prepared by the conventional casting method was impregnated with Si in the same manner as in EXAMPLE 3 to prepare the Si—SiC composite. FIG. 3 presents the photograph of its microstructure. Comparing the photograph shown in FIG. 1 with that shown in FIG. 3 for the impregnated cast, it is shown that the Si—SiC composite of the present invention is impregnated with Si in the pores left by burnt starch.

As discussed above, the method of the present invention for producing a metal/ceramic composite can produce the composite whose metal content can be freely changed as designed, and the one having a low impregnated metal content. It can also produce the metal/ceramic composite having a narrow distribution of metal over the entire body at low cost, even when it has a complex shape or varying thickness, or is very thick. Moreover, it can produce the metal/ceramic composite impregnated with a metal only in the vicinity of the surface area.

The method of the present invention for producing a porous ceramic body can produce the product having a narrow open porosity distribution over the entire body, irrespective of thickness or shape, at low facility cost, even when it has varying thickness, is very thick, or has a complex shape.

What is claimed is:

1. A method of producing a metal/ceramic composite, comprising the steps of:
adding starch to a ceramic slurry;
casting the slurry into a water-nonabsorptive mold;
heating the slurry to harden it to obtain a hardened body;
demolding the hardened body out of the mold;
drying the hardened body to obtain a molded body; and
then impregnating the molded body with a metal in its pores to obtain the metal/ceramic composite.

2. The method of producing a metal/ceramic composite according to claim 1, wherein said ceramic is silicon carbide and said metal is silicon or copper.

3. A method of producing a metal/ceramic composite, comprising the steps of:
adding starch to a ceramic slurry;
casting the slurry into a water-nonabsorptive mold;
heating the slurry to harden it to obtain a hardened body;
demolding the hardened body out of the mold;
drying the hardened body to obtain a molded body;
firing the molded body to obtain a porous ceramic body; and
impregnating the body with a metal in its pores to obtain the metal/ceramic composite.

4. The method of producing a metal/ceramic composite according to claim 3, wherein said ceramic is silicon carbide and said metal is silicon or copper.

5. A method of producing a porous ceramic body, comprising the steps of:
adding starch to a ceramic slurry;
casting the slurry into a water-nonabsorptive mold;
heating the slurry to harden it to obtain a hardened body;
demolding the hardened body out of the mold;
drying the hardened body to obtain a molded body; and
then firing the molded body to obtain the porous ceramic body, wherein the porous ceramic body is obtained by increasing a ceramic particle size so that firing-induced shrinkage of said body hardly occurs.

6. The method of producing a porous ceramic body according to claim 5, wherein open porosity of said porous ceramic body is made to be 30% or more but 60% or less by changing a starch content of said ceramic slurry.
